(19) United States
(12) Patent Application Publication
(10) Pub. No.: US 2024/0023709 A1
(43) Pub. Date: Jan. 25, 2024

(54) DOOR FOR PIECE OF FURNITURE AND PIECE OF FURNITURE

(71) Applicant: VD INVEST SA, Fribourg (CH)

(72) Inventor: Massimo VEZZONI, Sergnano (Cremona) (IT)

(21) Appl. No.: 18/255,008

(22) PCT Filed: Nov. 29, 2021
(86) PCT No.: PCT/IB2021/061072

§ 371 Date: May 30, 2023

(30) Foreign Application Priority Data
Dec. 4, 2020 (IT) 102020000029987

(51) Int. Cl. A47B 96/20; A47B 87/00; F16B 12/34; F16B 12/36

(52) U.S. Cl. CPC A47B 96/20; A47B 87/008; F16B 12/34; F16B 12/36; A47B 2096/207

(57) ABSTRACT

A door for a piece of furniture is provided. The door has an outer panel of transparent or translucent material, a printed sheet having a depiction or a decoration, and a finishing support frame made of one of a thin metal sheet, an aluminum section bar, a plastic material, and a glass fiber or carbon fiber material and having a finishing locking wall and/or an auxiliary finishing locking wall. One or more fixing elements are fixed to the outer panel, the one or more fixing elements being suitable for fixing the outer panel to the finishing locking wall and/or the auxiliary finishing locking wall in a removable manner. The printed sheet is anchored between the outer panel and the finishing locking wall and/or the auxiliary finishing locking wall. A piece of furniture including the door is also provided.

The present invention relates to a door for a piece of furniture and a corresponding piece of furniture.

Modular units are known in the art for the composition of box-shaped modules joined together to form pieces of furniture such as kitchens, bookcases, or display furniture for the home or office.

Typically, such solutions involve wooden modules that the end user or a specialized installer may join together to form the final piece of furniture. Subsequently, the corresponding doors are installed on the wooden modules for access to each compartment of the wooden module.

However, there are some problems with the known solutions.

First, the composition of a whole piece of furniture requires the transport of bulky and heavy modular elements or panels to the place of installation and the consequent need to predict and plan in advance the weight and volumes occupied for the transport.

Furthermore, once the type of furniture has been defined, it is not possible to rearrange the modular components to change their final appearance.

Moreover, in the systems of the prior art, it is generally not possible to vary the outer finishes of the furniture at will, nor is it possible to vary the finishes of each face of the box-shaped module that defines the basic modular element after the final installation of the furniture.

In other words, it is not possible to change over time, in a simple and immediate way, the shape and/or color of the walls that make up a compartment of the furniture.

Inconveniently, moreover, just as it is not possible to change the outer finish of the furniture over time, it is also not possible to change the finish of each door over time, without having to replace the entire door.

In addition, the modular compositions of the prior art are found to have modules with considerable thickness that are not suitable for making furniture with a light and linear aesthetic character, as well as being particularly heavy to move.

This is especially true for doors, which are often heavy to move, so that their strength is ensured over time or, when they are light, they are subject to deformations or flexing due to the inherent structure of the door, especially in the case of certain sizes.

Therefore, the need is strongly felt to propose a door for a piece of furniture and a piece of furniture that are able to overcome the drawbacks of the prior art.

This need is satisfied with a door for a piece of furniture and a piece of furniture according to the attached independent claims. The dependent claims describe preferred or advantageous embodiments.

The features and advantages of the door and of the piece of furniture will become apparent from the description below of its preferred embodiments, given by way of non-limiting example, with reference to the attached figures, wherein:

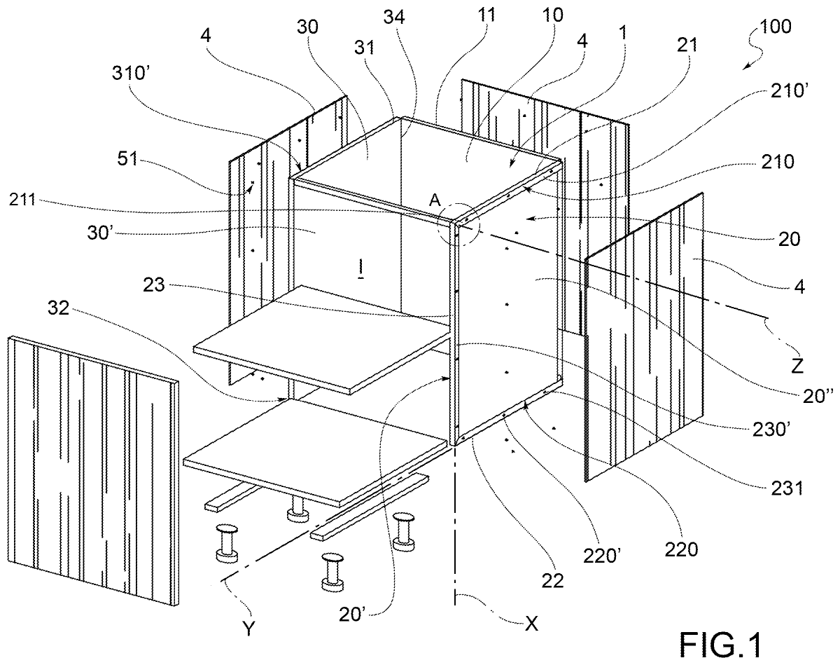

FIG. 1 shows an axonometric view of an exploded drawing of a box-shaped module for a piece of furniture according to one embodiment of this invention;

FIG. 1a shows an enlargement of a detail of FIG. 1;

FIG. 1b shows an axonometric view of an exploded drawing of a box-shaped module for a piece of furniture according to an embodiment of this invention, which differs substantially from the embodiment of FIG. 1 in the absence of a finishing element on the bottom panel;

FIG. 1c shows an axonometric view of an exploded drawing of a box-shaped module for a piece of furniture according to an embodiment of this invention, which differs with respect to the embodiment of FIG. 1 in that it includes a top covering finishing element and a bottom finishing element;

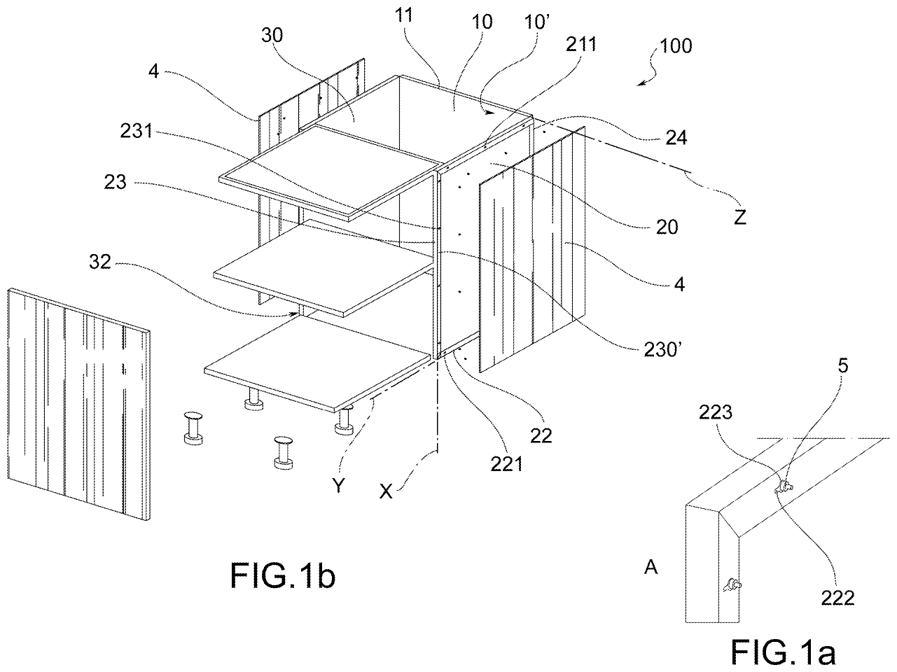

FIG. 2 shows an axonometric view of a metal sheet for making a modular unit in an unfolded configuration;

FIG. 2a shows an axonometric view of a modular unit obtained as a result of folding the metal sheet in FIG. 2;

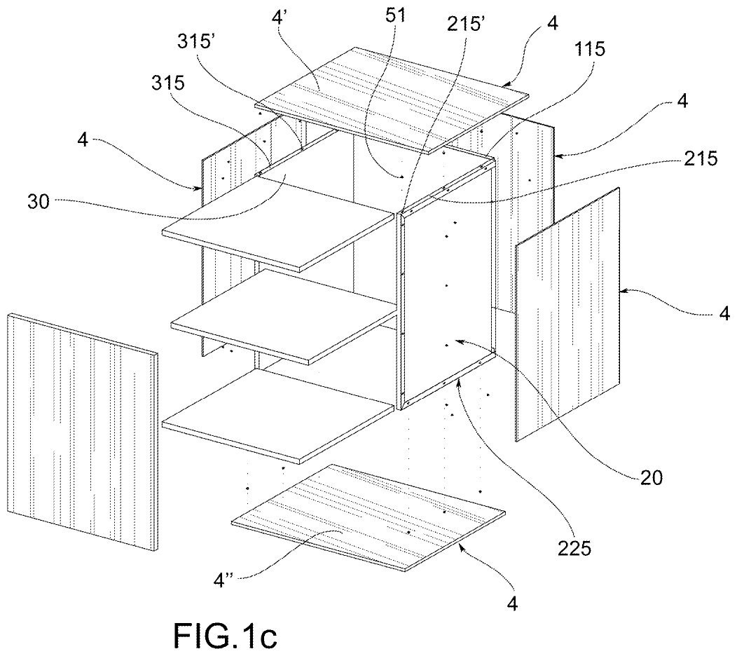

FIG. 3 shows an axonometric view of an exploded drawing of a box-shaped module for a piece of furniture according to a second embodiment of this invention;

FIG. 3a shows an axonometric view of the modular unit comprised in the box-shaped module for a piece of furniture of FIG. 3;

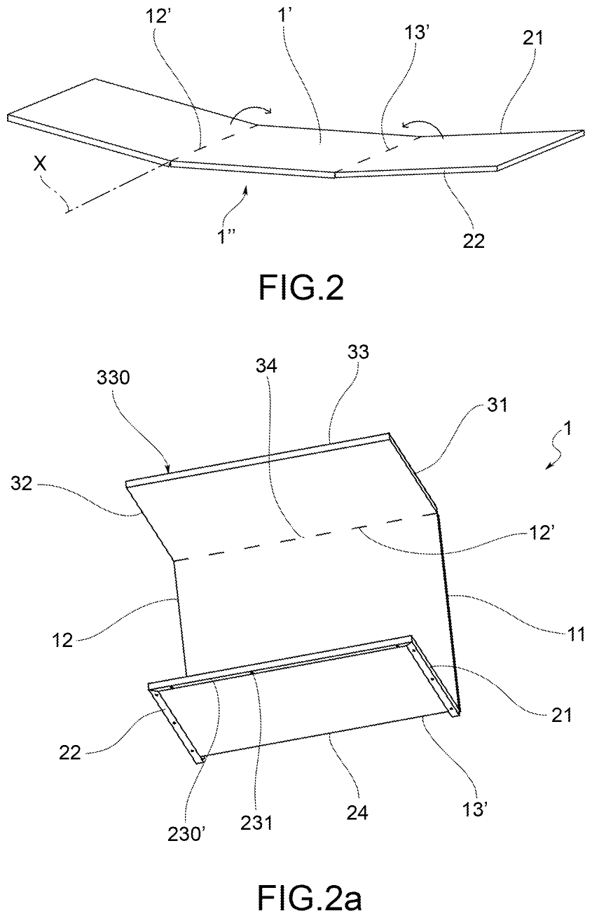

FIG. 4 shows an axonometric view of an exploded drawing of a piece of furniture according to an embodiment of this invention, made by joining two modular units and coupling at least two finishing elements;

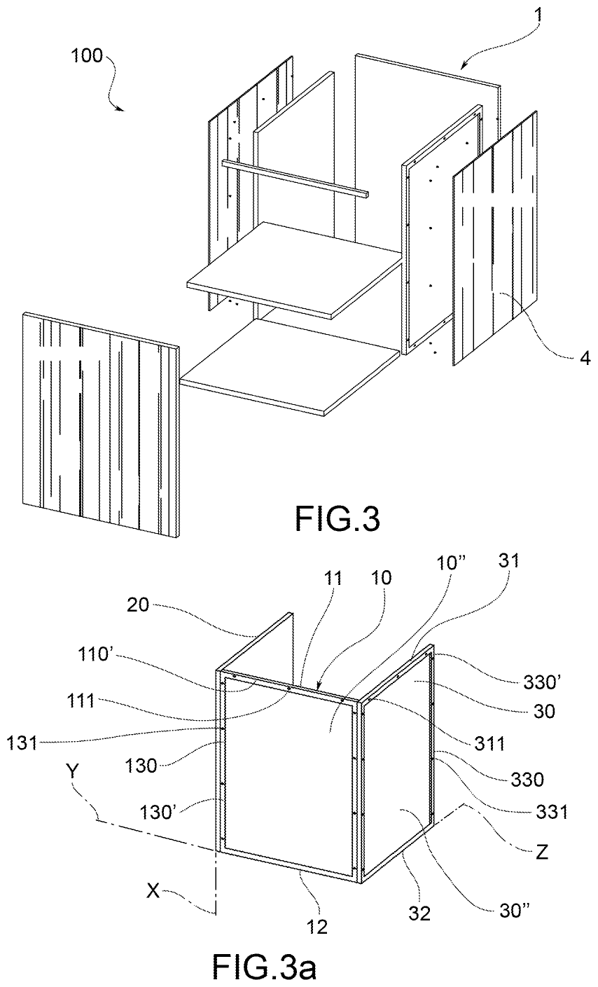

FIG. 5 is an enlarged detail of FIG. 4;

FIG. 5a shows an axonometric view of a module fixing element according to an embodiment of this invention;

FIG. 5b shows an axonometric view of a module fixing element according to a second embodiment of this invention;

FIG. 5c shows an axonometric view of a module fixing element according to a third variant embodiment of this invention;

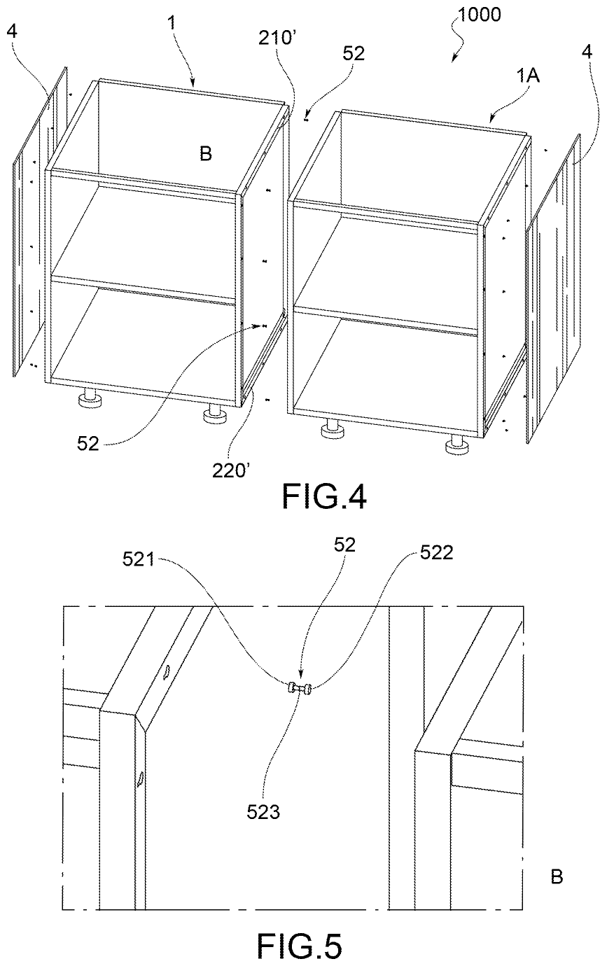

FIG. 6 shows a detail of a finishing element and a fixing element according to an embodiment of this invention;

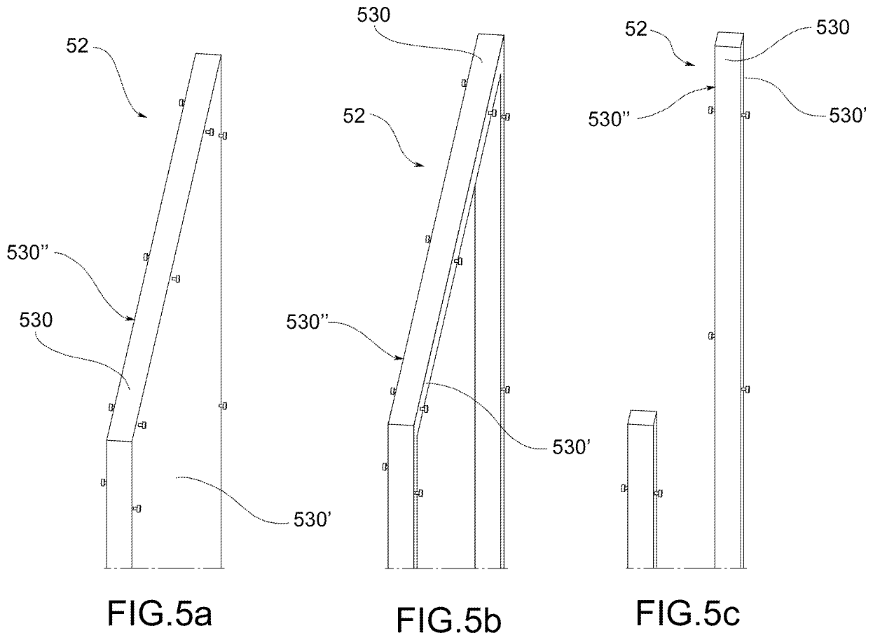

FIGS. 7 and 7a each show a configuration of a fixing element inserted into an elastic element according to an embodiment of this invention;

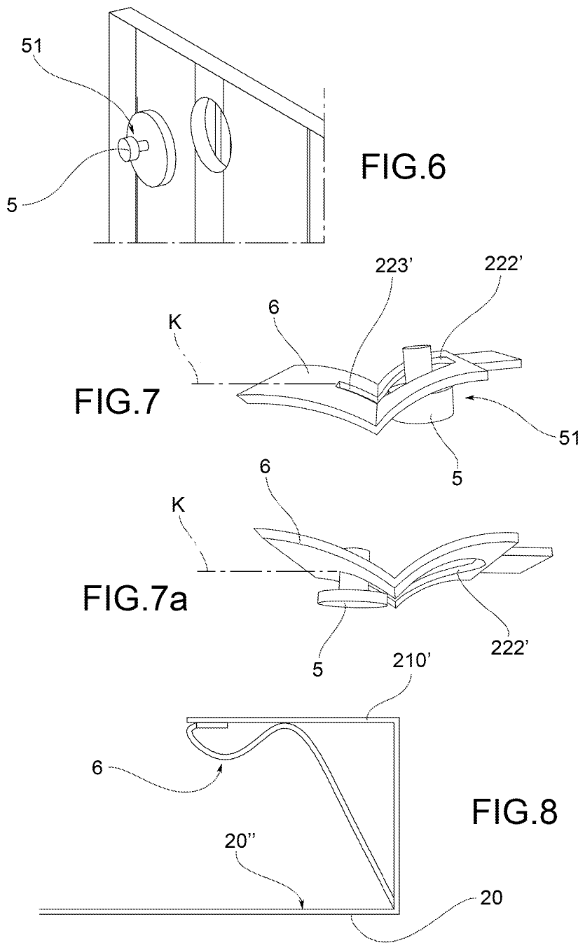

FIG. 8 shows a plan view from above of a section of a portion of a right panel of a modular unit and of an elastic element inserted into the right panel, in accordance with an embodiment according to this invention;

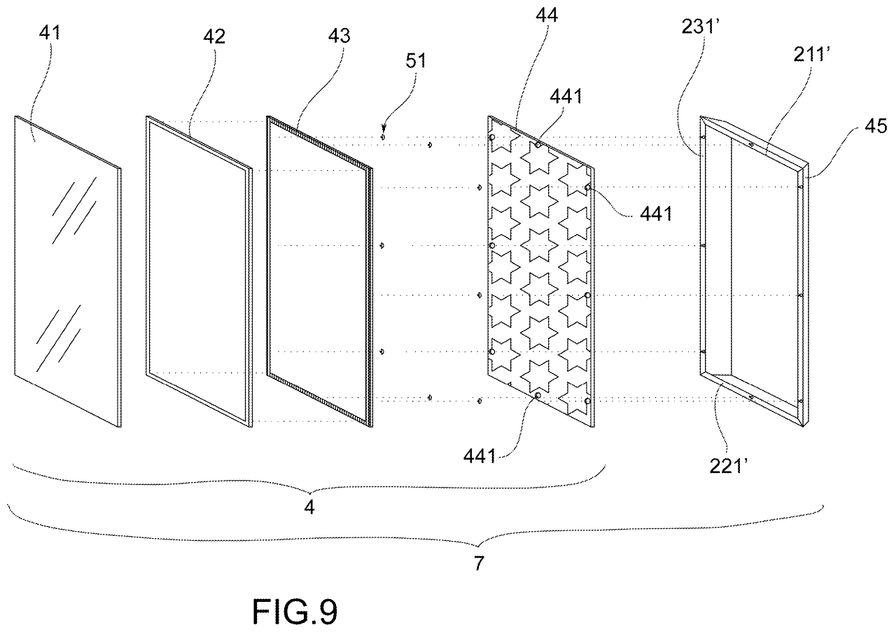

FIG. 9 shows an axonometric view of an exploded drawing of a finishing element according to an embodiment of this invention and a door according to an embodiment of this invention when the finishing element is coupled to a finishing support frame made of metal sheet;

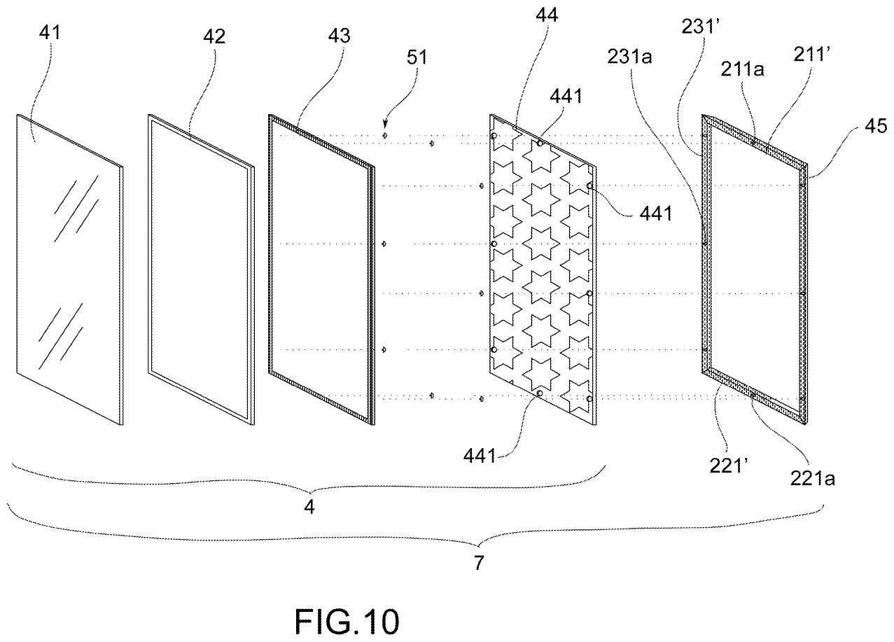

FIG. 10 shows an axonometric view of an exploded drawing of a finishing element according to another embodiment of this invention and a door according to another embodiment of this invention when the finishing element is coupled to a finishing support frame 45 made of aluminum;

FIG. 10a shows an axonometric view of a door according to an embodiment of this invention when the finishing element is coupled to a finishing support frame, preferably made of aluminum;

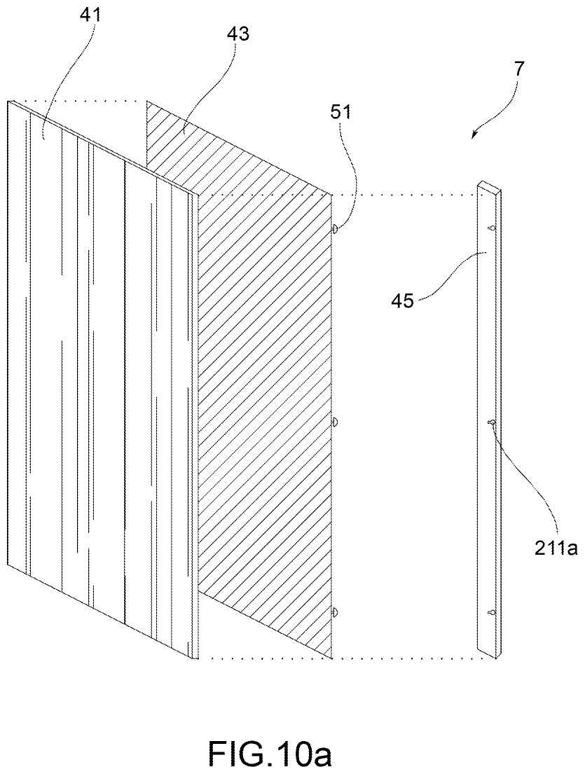

FIG. 11 shows an axonometric view of an exploded drawing of a finishing element according to a further embodiment of this invention and a door according to a further embodiment of this invention when the finishing element is coupled with a finishing support frame made of metal sheet;

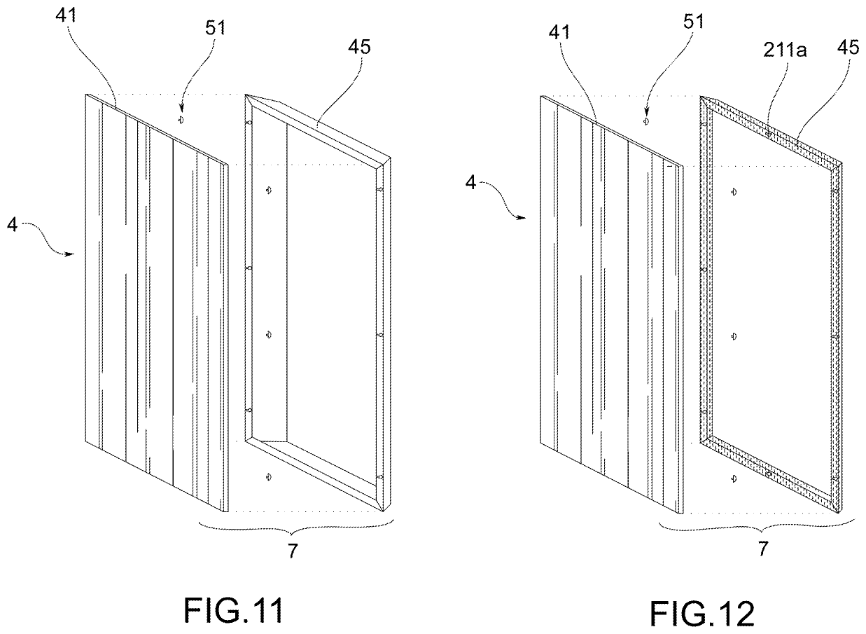

FIG. 12 shows an axonometric view of an exploded drawing of a finishing element according to another embodiment of this invention and a door according to another embodiment of this invention when the finishing element is coupled with a finishing support frame made of aluminum.

With reference to the aforesaid figures, according to one aspect of this invention, the reference number 1 is used to collectively refer to a modular unit 1 for the composition of a box-shaped module 100, 101 for a piece of furniture, for example for a modular kitchen or a bookcase or a cabinet or for bathroom furniture and the like.

Said modular unit 1 comprises a bottom panel 10, a right panel 20, and a left panel 30, made of thin metal sheet and coupled together to define an inner cavity I with an open box shape.

Each panel of said right 20 and left panels 30 comprises an inner panel face 20′, 30′, facing the inner cavity I and an outer panel face 20″, not facing the inner cavity I. Moreover, each right panel 20 or left panel 30 extends primarily according to a first extension direction X and a second extension direction Y perpendicular to the first extension direction X and, to a much lesser extent, in a third extension direction Z perpendicular to the first X and second extension direction Y. In other words, each right panel 20 or left panel 30 is a panel of small thickness in the third extension direction Z. Preferably, the thin metal sheet is a thin sheet of steel, less than 2 millimeters thick in the extension direction Z, even more preferably less than 1 millimeter thick.

Each of said right 20 and left 30 panels comprises at least one upper panel edge 21, 31 and one lower panel edge 22, 32 that delimit the panel extension along the first extension direction X.

Further, in the vicinity of said upper edge 21, 31 and lower edge 22, 32, each right or left panel 20, 30 comprises a fold 210, 220 of the metal sheet comprising a locking wall 210′, 220′; 310′ extending along the first extension direction X in a manner much less than the extension of the entire panel along the same first extension direction X and being spaced apart from the outer panel face 20″. In other words, the locking wall 210′, 220′, 230′ is a lip spaced apart from the outer panel face 20″. Preferably, said lip extends along the first extension direction X by a length of less than 10% with respect to the extension of the entire panel along the same first extension direction X, even more preferably by a length of less than 5% with respect to the extension of the entire panel along the same first extension direction X.

On said locking wall 210′, 220′; 310′ fixing openings 211, 221, 311 are obtained for removably fixing a finishing element 4 or an equal modular unit 1.

The bottom panel 10 also comprises an inner panel face 10′ facing the inner cavity I and an outer panel face 10″, not facing the inner cavity I. Further, the bottom panel 10 also preferably extends primarily according to a first extension direction X and a second extension direction Y perpendicular to the first extension direction X and, to a much lesser extent, in a third extension direction Z perpendicular to the first X and second extension direction Y.

In other words, each bottom 10, right 20, or left 30 panel has a small thickness in the third extension direction Z.

Further, preferably, each panel 10, 20, 30 has a square or rectangular plan shape.

Also each bottom panel 10 comprises at least one top panel edge 11 and one bottom panel edge 12 that delimit the panel extension along the first extension direction X.

According to a variant embodiment, near said top edge 11 and bottom edge 12, each bottom panel 10 comprises a fold of the metal sheet comprising a locking wall 110′ extending along the first extension direction X in a manner much less than the extension of the entire panel along the same first extension direction X and being spaced apart from the outer panel face 10″, in a manner entirely analogous to that previously described for the right panel 20 or the left panel 30. Therefore, in a similar manner, fixing openings 111 are provided on the locking wall 110′ of the bottom panel 10 for removably fixing a finishing element 4 or an equal modular unit 1.

Preferably, the fixing openings 111, 211, 221, 311 are through openings.

According to an embodiment, not shown in the figures, the modular unit 1 comprises a reinforcing panel, joined to the bottom panel 10 and/or the right panel 20 and/or to the left panel 30 along the outer panel face 10″, 20″, 30″, preferably joining by sandwiching or bonding. Preferably, in this variant, the reinforcing panel is sandwiched between the locking wall 110′, 210′, 220′; 310′ and the outer panel face 10″, 20″, 30″. Preferably, the reinforcing panel is received in the U-shaped seat formed between the locking wall 110′, 210′, 220′, 310′ and the outer panel face 10″, 20″, 30″. Preferably, the reinforcing panel is only sandwiched between the locking wall 110′, 210′, 220′, 310′ and the outer panel face 10″, 20″, 30″, without any additional bonding. Preferably, the reinforcing panel is made of a non-metallic material. For example, it is a multilayer material with synthetic resins, such as laminate or melamine multilayer or chipboard material, or it is plastic resin or melamine resin or honeycomb PET.

According to an advantageous embodiment, the bottom panel 10, the right panel 20, and the left panel 30 are made in one piece and obtained by folding a single sheet 1′, preferably along weakenings 12′, 13′ of the sheet 1′, as for example shown in FIGS. 1 to 2a.

Preferably, each of said right panel 20 and left panel 30 comprises at least one left panel edge 23, 33 and one right panel edge 24, 34 delimiting the extension of the panel along the second extension direction Y. Near at least the left edge 23, 33 each of said left and right panels comprises an auxiliary fold 230, 330 of metal sheet comprising an auxiliary locking wall 230′, 330′ extending along the second extension direction Y in a manner much less than the extension of the entire panel along the same second extension direction Y. Said auxiliary locking wall 230′, 330′ is spaced apart from the outer panel face 20″, 30″. In addition, auxiliary fixing openings 231, 331 are provided on said auxiliary locking wall 230′, 330′ for removably fixing a finishing element 4 or an equal modular unit 1.

Preferably, the auxiliary locking wall 230′, 330′ extends along the second extension direction Y by a length of less than 10% with respect to the extension of the entire panel along the same second extension direction Y, even more preferably by a length of less than 5% with respect to the extension of the entire panel along the same second extension direction Y.

It is clear that, in a variant embodiment, the bottom panel 10 also comprises an auxiliary fold 130 and an auxiliary locking wall 130′, which is entirely analogous to that which is described in the preceding paragraph for the right panel 20 or left panel 30.

Preferably, the fixing openings 111, 211, 221 and the auxiliary fixing openings 131, 231, 331 are eyelets comprising a reduced section region 222 with respect to a normal section region 223 to allow a head of a screw or nail 5 to pass through the normal section region 223 and to prevent the screw or nail 5 from emerging from the reduced section region 222, as for example shown in FIG. 1a.

According to an embodiment, behind the locking wall 110′; 210′, 220′; 310′ and/or behind the auxiliary locking wall 130′, 230′, i.e., on the side of the locking wall or auxiliary locking wall facing the outer panel face 20″, in the vicinity of one or more of the fixing openings 111, 211, 221 or auxiliary fixing openings 131, 231 at least one elastic element 6 is positioned, which is suitable for undergoing elastic deformation and for “snap-fixing” onto the screw or nail 5, as for example shown in FIGS. 7, 7a, and 8. This is done in such a way that the translation of the screw or nail 5 along a direction K perpendicular to the direction of insertion of the screw/nail into the fixing openings or auxiliary fixing openings is prevented. Said screw insertion direction is essentially parallel to the third extension direction Z.

According to an embodiment, for example shown in FIGS. 7 and 7a, the elastic element 6 comprises an elastic element eyelet having a reduced section region 222′ with respect to a normal section region 223′ to allow a head of a screw or nail 5 to pass through the normal section region 223′ and prevent the screw or nail 5 from emerging from the reduced section region 222′.

According to an embodiment, for example shown in FIG. 1c, the right panel 20 and/or the left panel 30 and/or the bottom panel 10, in the vicinity of the top panel edge 21, 31 or the bottom panel edge 22, 32 comprises a horizontal locking wall 115, 215, 315, 225 extending in a plane parallel to the third extension direction Z and possibly perpendicular only to the first extension direction X.

On said horizontal locking wall 115, 215, 315, 225 fixing openings 215′, 315′ are obtained for removably fixing a finishing element 4 or an equal modular unit 1. As shown in FIG. 1c, in this variant, the finishing element 4, when secured by the fixing elements 51 in the fixing openings 215′, 315′, constitutes a top covering finishing element 4′, such as a kitchen top element or the like, or a bottom finishing element 4″.

As may be appreciated from the above description and figures, all finishing elements are therefore preferably fixed in a removable manner by means of the fixing elements 51 and, therefore, without the use of permanent fixing elements such as screws or nails or glues, which, if removed, would compromise the integrity of the finishing element or of the modular unit and, in any case, would require longer assembly/disassembly times.

According to a further aspect of this invention, a box-shaped module 100, 101 for a piece of furniture, for example shown in FIGS. 1, 1b, and 3, comprises a modular unit 1, described in the preceding paragraphs, and at least one finishing element 4 on which fixing elements 51 are anchored that are inserted into one or more fixing openings 211, 221 and/or one or more auxiliary fixing openings 231 of the modular unit 1.

The finishing element 4 is also to be considered per se an aspect of this invention and is for example shown in its variant embodiments in FIGS. 9 to 12. It should be noted that, in said figures, the finishing element 4 and a door 7, subject of this invention, formed by joining the finishing element 4 with a finishing support frame 45, are represented at the same time. Thus, the finishing element 4 when coupled with the finishing support frame 45 results in a door according to this invention while when coupled with a modular unit 1 it serves as a finishing element per se of the modular unit, constituting a box-shaped module 100, 101.

According to one aspect of this invention, for example with particular reference to FIGS. 9 and 10, the finishing element 4 comprises an outer panel 41 made of a transparent or translucent material and a printed sheet 44 comprising a depiction or decoration. The printed sheet 44 is stably anchorable between the outer panel 41 and the locking wall 211, 221 and/or the auxiliary locking wall 231. Additionally, one or more fixing elements 51, such as nails or screws, suitable for being inserted into the fixing openings 211, 221 and/or in the auxiliary fixing openings 231 are fixed on the outer panel 41.

Preferably, the printed sheet 44 comprises anchoring openings 441 suitable for being crossed by the fixing elements 51.

Preferably, the printed sheet 44 is removably retained between the outer panel 41 and the locking wall 211, 221, without any further definitive fixing means, such as glue or screws, but is retained only by being trapped between the outer panel 41 and the locking wall 211, 221 and/or the auxiliary locking wall 231, and possibly supported by the fixing elements 51.

According to an advantageous embodiment, the outer panel 41 comprises a support frame 43 joined to the outer panel 41, preferably by an adhesive layer 42. In this variant, the one or more fixing elements 51 are attached to the support frame 43, and the printed sheet 44 is anchored to the support frame 43 by the one or more fixing elements 51. This provides adequate strength to the finishing element 4 while ensuring interchangeability of the printed sheet.

It is clear that in this discussion, decoration or depiction means any figurative element or even a simple solid color or texture or pattern.

According to an advantageous embodiment, a lighting element (not shown), for example an LED strip, is housed on the support frame 43, in the space between the printed sheet 44 and the outer panel 41, or on the finishing support frame 45, so as to backlight the outer panel 41.

According to a variant embodiment, the lighting element is housed behind the locking wall 210′, 220′; 310′ and/or behind the auxiliary locking wall 230′, i.e., on the side of the locking or auxiliary locking wall facing the outer panel face 20″.

Preferably, the finishing element 4 has a thickness of less than or equal to twenty-five millimeters, even more preferably less than or equal to eight millimeters or less than or equal to five millimeters.

According to a further aspect of this invention, for example shown in FIGS. 11 and 12, the finishing element 4 comprises an outer panel 41 directly comprising an embodiment or decoration. One or more fixing elements 51, for example nails or screws, for removably anchoring to the locking wall 211, 221 and/or the auxiliary locking wall 231 are fixed to said outer panel 41. In this variant, the outer panel 41 has a thickness of less than or equal to twenty-five millimeters or more preferably less than or equal to eight millimeters, even more preferably less than or equal to five millimeters.

Preferably, the finishing element 4 is made of stone, or metal, or stoneware, or medium-density fiberboard (MDF), or polyvinyl chloride (PVC), or polyethylene or polyethylene terephthalate (PET), or glass, or HPL (high pressure laminate), or polycarbonate.

As will be understood from the preceding paragraphs, it is therefore an object of this invention to provide a door 7 for a piece of furniture, preferably anchorable in a rotatable manner to the piece of furniture or in any case to a modular unit 1 of a piece of furniture.

It is clear that the door 7 of this invention is preferably anchorable to a piece of furniture or a modular unit 1 described herein, but it is also clear that the door 7 is anchorable to any piece of furniture of the prior art, for example made with wooden modules, for example by means of suitable hinges. Therefore, the door 7 of this invention, is not to be considered strictly bound to engage with a modular unit 1 described herein. The door 7 comprises a finishing element 4, according to the previously described variants, and a finishing support frame 45 preferably made of thin metal sheet or aluminum section bar or plastic material or glass or carbon fiber. Said finishing support frame 45 comprises a finishing locking wall 211′, 221′ and/or an auxiliary finishing locking wall 231′. One or more fixing elements 51 of the outer panel 41 removably fix the outer panel 41 to the finishing locking wall 211′, 221′ and/or the auxiliary finishing locking wall 231′.

In the variant wherein the finishing element 4 comprises the printed sheet 44, said printed sheet 44 is anchored between the outer panel 41 and the finishing locking wall 211′, 221′ and/or the auxiliary finishing locking wall 231′, preferably being crossed by the fixing elements 51, which allow it to be held in place and prevent it from slipping.

It is clear that, similarly to the modular unit 1, behind the finishing locking wall 211′, 221′ and/or the auxiliary finishing locking wall 231′, in the vicinity of one or more finishing fixing openings 211a, 221a, or auxiliary finishing fixing openings 231a at least one elastic element 6 is positioned suitable for undergoing elastic deformation and for “snap-fixing” onto one or more fixing elements 51, such as a nail or screw 5. This is done in such a way that translation of the screw or nail 5 along a direction K perpendicular to the direction of insertion of the screw/nail into the finishing fixing openings or auxiliary finishing fixing openings is prevented.

Preferably, therefore, the features of the locking walls 210′, 220′; 310′ and auxiliary locking walls, as well as the fixing openings 211, 221, 311 and auxiliary fixing openings and their interactions with the fixing elements 51, are to be considered equally understood and valid in the finishing locking wall 211′, 221′, in the auxiliary finishing locking wall 231′, and in the finishing fixing openings 211a, 221a, or auxiliary finishing fixing openings 231a. This ensures full interchangeability compatibility between finishing elements 4 applicable to the right, left, lower, and bottom panels of the modular unit, as well as the finishing support frame 45 for the door 7.

Preferably, the door 7 comprises a release button (not shown), suitable for activating or deactivating the elastic element 6, i.e., mechanically interfering therewith, so as to allow the release of the outer panel 41.

It is also clear that for the person skilled in the art, the term “support frame” means any frame or a simple profile or a more complex metal structure.

For example, according to an advantageous embodiment, e.g., shown in FIG. 10a, the finishing support frame 45 is simply a metal bar, preferably made of aluminum, having preferential extension in the first extension direction X and does not have any further support components, i.e., it is not shaped, for example, as a frame, as for example shown in other variant embodiments. In this variant, preferably, the support frame 43 joined to the outer panel 41, preferably by an adhesive layer 42, is a thin metal sheet in the form of a frame or in the form of an entire thin metal sheet. Furthermore, in this variant, preferably the one or more fixing elements 51 are fixed to the thin metal sheet, for example they are welded or press-fit or glued. This results in a lightweight, extremely thin, strong cabinet door with all the advantages provided by a finishing element. It is clear that all of the previously described outer panel 41 and printed sheet 44 variants are applicable to this support frame 43 and finishing support frame 45 variant; moreover, all of the finishing element 4 variants described in this discussion are applicable with the difference that the support frame 43 is either a thin metal sheet in the form of a frame or in the form of a whole thin metal sheet.

Preferably, the finishing support frame 45 integrally houses or directly supports (e.g., is fixed to) one or more hinges for moving the door 7.

Additionally, it is an object of this invention to provide a piece of furniture 1000, for example shown in FIG. 4 comprising at least two modular units 1, 1A described in the preceding paragraphs, joined together by module fixing elements 52 inserted into one or more fixing openings 211, 221 and/or one or more auxiliary fixing openings 231 of each modular unit 1, 1A. The module fixing elements are preferably pins or nails having a double head, as for example shown in FIG. 5. In other words, pins or nails comprise a left head 521 and a right head 522 joined together by a central connecting member 523 having a reduced cross-section with respect to the cross-section of the head. The left head 521 is suitable for being inserted into the fixing openings 211, 221 and/or auxiliary fixing openings 231 of one 1 of the two modular units 1, 1A, while the right head 522 is suitable for being inserted into the fixing openings 211, 221 and/or auxiliary fixing openings 231 of the other 1A of the two modular units 1, 1A, adjacent to the first. In this way, it is possible to obtain a quick, simple, and effective coupling of the modules, without the need to provide for onerous screw fixing operations that would, moreover, ruin the modular units.

According to a variant embodiment, for example shown in FIGS. 5a to 5c, the module fixing elements 52 comprise a fixing frame 530, comprising a right frame face 530′ and a left frame face 530″, which are opposite each other. One or more pins or nails, preferably having an enlarged head, and suitable for being inserted into the fixing openings 211, 221 and/or auxiliary fixing openings 231 of one 1 of the two modular units 1, 1A are fixed or formed into each right frame face 530′ and left frame face 530″. In particular, when the fixing frame 530 is installed between two modular units 1, 1A, the pins or nails fixed to the right frame face 530′ are inserted into the fixing openings 211, 221 and/or auxiliary fixing openings 231 of one of the two modular units 1, 1A, while the pins or nails fixed to the left frame face 530″ are inserted into the fixing openings 211, 221 and/or auxiliary fixing openings 231 of the other of the two modular units 1, 1A. In this way, a quick, simple, and effective coupling of the modules is obtained, without the need to provide for onerous screw fixing operations, and at the same time it is possible to meet any need for padding between the modules, also ensuring greater flexibility in the design and filling of spaces wherein the piece of furniture is housed.

Further, an aspect of this invention is a method for making a modular unit 1, previously described.

The aforesaid method is best understood in reference to FIGS. 2 and 2a and comprises the following operational steps:
providing a metal sheet 1′, preferably having weakenings 12′, 13′ extending along the first extension direction X, and comprising an upper edge 21 and a lower edge 22, wherein in the vicinity of said lower edge 22 and upper edge 21, said metal sheet 1′ comprises a fold 210, 220 of the metal sheet comprising a locking wall 210′, 220′; 310′ extending along the first extension direction X in a manner much less than the extension of the entire metal sheet 1′ along said first extension direction X and being spaced apart from an outer sheet face 1″;
folding the metal sheet 1′, preferably along the weakenings 12, 13′, to obtain the modular unit 1 so that the bottom panel 10 ends up between the right panel 20 and the left panel 30 and, preferably, between two weakenings 12′, 13′.

It is clear that in the case of the presence of weakenings in the sheet metal, such as incisions, notches, holes or micro-holes or the like, it is easier to fold the metal sheet at the site of installation. In the case of the absence of such weakenings, however, it is preferable to carry out the folding or at least a partial folding of the sheet metal at the factory before transport to the site of installation.

It is clear that the aforesaid construction method refers to a variant embodiment wherein the modular unit 1 is made from a one-piece sheet 1′. However, it is clear that, according to another construction method, the modular unit 1 may also be made by joining together three distinct bottom panels 10, right panels 20, and left panels 30, as for example shown in FIGS. 3 and 3a.

Moreover, after making the modular unit 1, the method comprises the step of coupling one or more finishing elements 4 to the modular unit by inserting the fixing elements 51 into one or more fixing openings 211, 221 or auxiliary fixing openings 231, so as to make a box-shaped module.

Innovatively, this invention overcomes the drawbacks of the doors and pieces of furniture of the prior art.

In an extremely innovative way, this invention allows manufactured articles to be redesigned and customized according to the particular final destination, due to the easy versatility of the doors and to their simultaneous strength of construction and lightness.

The extreme modularity and interchangeability of the finishing elements and doors, together with a light, thin, and traditional screwless structure results in a piece of furniture with unique and distinctive features in the sector.

In particular, for example, it is possible at any time to rearrange the arrangement of the printed sheets on the door or in the finishing elements without any decoration or gluing operations or without any marks or holes remaining in the panels.

Moreover, it is possible to obtain multicolor modular units, variable at will in the same piece of furniture. In particular, in the same box-shaped module it is possible to have faces with different colors and/or materials, as well as doors with different colors and materials without special and complex maintenance operations.

It is clear that each finishing 4 or door 7 element may also cover only partially or completely the support frame or the right panel 20, left panel 30, or bottom panel 10. This allows for a variability of decorations to be obtained even in the same door or in the same side of the box-shaped module.

In addition, in a particularly advantageous way, the modular unit, the finishing element, or the door, for the parts made of metal sheet, are environmentally friendly, completely recyclable, non-flammable, and water-resistant. In particular, being made of metal sheet such as steel or aluminum, they are recyclable, as well as being solid, durable, and easily washable.

In particular, the presence of a folded sheet equipped with fixing openings allows an effective and simple coupling between the modular unit and the finishing element, as well as between adjacent modular units or between the finishing element and the support frame for constructing the door.

This further allows for a rapid installation of an entire piece of furniture without the need for costly fixing operations using screws of different sizes and pins.

Moreover, due to the possibility of repositioning the finishing elements on the modular unit in a simple way, it is possible to change the outer finish of the furniture over time, as well as vary the type of decoration of said piece of furniture, with the possibility of obtaining various shapes and different colors.

In addition, the possibility of changing only the printed sheet of the finishing element is advantageous, as it allows the aesthetic appearance of the furniture to be modified at will over time, without having to change an entire side panel or even an entire module. Furthermore, the same benefit applies to the door.

Also advantageously, making the modular unit in metal sheet of small thickness allows an agile and easy transport, as well as an agile assembly operation, being extremely light compared to the wooden modular units of the prior art.

In addition, the variant of a modular unit made by means of the metal sheet in a single body folded along the weakenings further facilitates the storage and transportation operations of the modular units. In effect, unfolded sheets may be easily stacked and stored in extremely small spaces with respect to a pre-assembled box-shaped modular unit that is typical of the prior art. Similarly, it is also possible to collect and assemble numerous panels to make a piece of furniture.

The operator installing the modular unit according to this invention need only transport the unfolded sheets to the installation site of the module and proceed with the folding operation on site to obtain the box-shaped module along the weakenings on the sheet metal.

Thus, in an extremely innovative way the modular unit allows manufactured items to be redesigned and customized according to the particular final destination, without having to make custom pieces or decorations and allowing the space of the room to be used in a simple and optimal way. The extreme modularity and interchangeability of the finishing elements and doors, together with a light, thin, and screwless structure, is unique in the industry.

Moreover, it is possible at any time to rearrange the arrangement of the printed sheets without any decorating or gluing operations or without any marks or holes remaining in the panels.

Moreover, it is possible to obtain multicolor modular units, variable at will in the same piece of furniture. In particular, it is possible to have faces in the same box-shaped module with different colors and/or materials.

It is clear that each finishing element 4 may also cover only partially or completely the support frame or the right panel 20, left panel 30, or bottom panel 10. This allows for a variability of decorations to be obtained even in the same door or in the same side of the box-shaped module.

Also advantageously, the possibility of making finishing elements of limited thickness, for example down to dimensions of less than 8 millimeters, allows an easy transportability of panels and doors and therefore an easy distribution in many places, even at a great distance.

A person skilled in the art may, in order to meet specific needs, make several changes to the embodiments of this invention or substitutions of elements with other functionally equivalent ones.

These variants are also contained within the scope of protection as defined by the following claims.

What is claimed is:

1. A door for a piece of furniture, rotatably anchorable to the piece of furniture, said door comprising:
an outer panel made of a transparent or translucent material,
a printed sheet, comprising a depiction or a decoration,
a finishing support frame made of one of a thin metal sheet, an aluminum section bar, a plastic material, and a glass fiber or carbon fiber material, the finishing support frame comprising a finishing locking wall and/or an auxiliary finishing locking wall, one or more fixing elements, being fixed onto said outer panel, the one or more fixing elements being suitable for fixing the outer panel to the finishing locking wall and/or to the auxiliary finishing locking wall in a removable manner,
said printed sheet being anchored between the outer panel and the finishing locking wall and/or the auxiliary finishing locking wall.

2. The door of claim 1, wherein the printed sheet is removably retained between the outer panel and the finishing locking wall and comprises anchoring openings suitable for being crossed by the one or more fixing elements.

3. The door of claim 1, wherein the outer panel comprises a support frame joined to the outer panel, wherein the one or more fixing elements are fixed to the support frame, and wherein the printed sheet is anchored to the support frame by the one or more fixing elements.

4. The door of claim 3, wherein a lighting element, is accommodated on the support frame, in a space between the printed sheet and the outer panel, or on the finishing support frame.

5. A door rotatably anchorable to a piece of furniture, said door comprising:
an outer panel comprising a depiction or a decoration,
a finishing support frame made of one of a thin metal sheet, an aluminum section bar, a plastic material, and a glass fiber or carbon fiber material, said finishing support frame comprising a finishing locking wall and/or an auxiliary finishing locking wall, one or more fixing elements being fixed onto said outer panel, the one or more fixing elements removably fixing the outer panel to the finishing locking wall and/or to the auxiliary finishing locking wall,
said outer panel having a thickness lower than or equal to twenty-five millimeters.

6. The door of claim 1, wherein the outer panel is made of one of stone, metal, stoneware, medium-density fiberboard (MDF), polyvinyl chloride (PVC), polyethylene terephthalate (PET), and glass.

7. The door of claim 1, further comprising one or more finishing fixing openings formed in the finishing locking wall and/or one or more auxiliary finishing fixing openings formed in the auxiliary finishing locking wall,
wherein, at least one elastic element is positioned behind the finishing locking wall and/or behind the auxiliary finishing locking wall, close to the one or more finishing fixing openings and/or the one or more auxiliary finishing fixing openings, the at least one elastic element being suitable for undergoing an elastic deformation and snap-fix the one or more fixing elements, optionally the one or more fixing elements being a nail or a screw, so that the nail or the screw is prevented from translating along a direction perpendicular to an insertion direction of the nail or of the screw in the finishing fixing openings or auxiliary finishing fixing openings.

8. A piece of furniture, comprising at least two modular units, each modular unit of said two modular units comprising:
a bottom panel, a right panel, and a left panel, made of a thin metal sheet and coupled to one another defining an open box-shaped inner cavity, each of said right and left panels comprising an inner panel face, facing the inner cavity, and an outer panel face, not facing the inner cavity and extending mainly according to a first extension direction and a second extension direction perpendicular to the first extension direction and extending much less in a third extension direction perpendicular to the first and second extension directions, having a small thickness in the third extension direction,
wherein each of said right and left panels comprises at least one upper panel edge and a lower panel edge that delimit an extension of the panel along the first extension direction,
wherein, close to said upper and lower panel edges, each panel comprises a fold of the metal sheet comprising a locking wall extending along the first extension direction much less than the extension of the entire panel along the first extension direction and being spaced apart from the outer panel face,
fixing openings being formed on said locking wall for removably fixing an equal modular unit,
wherein the at least two modular units are joined to each other by module fixing elements inserted into one or more of the fixing openings and/or auxiliary fixing openings of each of said at least two modular units, and wherein
said piece of furniture comprises at least one door according to claim 1, rotatably anchored to at least one of the two modular units.

9. The piece of furniture of claim 8, wherein the bottom panel, the right panel and the left panel are made in a single piece and obtained by folding a single sheet along weakenings of the sheet.

10. The piece of furniture of claim 8, wherein each of said right and left panels comprises at least one left panel edge and one right panel edge that delimit the extension of the panel along the second extension direction,
wherein, close to at least said left panel edge, each panel comprises an auxiliary fold of the metal sheet comprising an auxiliary locking wall extending along the second extension direction much less than the extension of the entire panel along the second extension direction and being spaced apart from the outer panel face,
auxiliary fixing openings being formed on said auxiliary locking wall for removably fixing a finishing element or an equal modular unit,

11. The piece of furniture of claim 8, wherein the fixing openings and the auxiliary fixing openings are eyelets comprising a reduced section region compared to a normal section region to allow a head of a screw or of a nail to pass from the normal section region and prevent the screw or the nail from exiting the reduced section region.

12. The piece of furniture of claim 11, wherein at least one elastic element is positioned behind the locking wall and/or behind the auxiliary locking wall, on a side of the locking wall facing the outer panel face, close to one or more of the fixing openings or auxiliary fixing openings, the at least one elastic element being suitable for undergoing an elastic deformation and snap-fix the screw or the nail so that a translation of the screw or of the nail is prevented along a direction perpendicular to an insertion direction of the screw into the fixing openings or auxiliary fixing openings, said insertion direction being substantially parallel to the third extension direction.

13. The piece of furniture of claim 12, wherein the at least one elastic element comprises an elastic element eyelet having a reduced section region compared to a normal section region to allow the head of the screw or of the nail to pass from the normal section region of the elastic element eyelet and prevent the screw or the nail from exiting the reduced section region of the elastic element eyelet.

14. The piece of furniture according of claims 8 to 13, wherein at least one of the right panel, the left panel, and the bottom panel, close to the upper panel edge or the lower panel edge, comprises a horizontal locking wall extending on a plane parallel to the third extension direction and optionally perpendicular only to the first extension direction, fixing openings being formed on said horizontal locking wall for removably fixing a finishing element or an equal modular unit.

15. The piece of furniture of claim 8, further comprising at least one finishing element, wherein fixing elements inserted into one or more fixing openings or auxiliary fixing openings are anchored onto the at least one finishing element.

16. The door of claim 5, wherein the outer panel is made of one of stone, metal, stoneware, medium-density fiberboard (MDF), polyvinyl chloride (PVC), polyethylene terephthalate (PET), and glass.

17. The door of claim 5, comprising one or more finishing fixing openings formed in the finishing locking wall and/or one or more auxiliary finishing fixing openings formed in the auxiliary finishing locking wall,
wherein, at least one elastic element is positioned behind the finishing locking wall and/or behind the auxiliary finishing locking wall, close to the one or more finishing fixing openings and/or the one or more auxiliary finishing fixing openings, the at least one elastic element being suitable for undergoing an elastic deformation and snap-fix the one or more fixing elements, optionally the one or more fixing elements being a nail or a screw, so that the nail or the screw is prevented from translating along a direction perpendicular to an insertion direction of the nail or of the screw in the finishing fixing openings or auxiliary finishing fixing openings.
